(19) United States
(12) Patent Application Publication
(10) Pub. No.: US 2014/0372264 A1
(43) Pub. Date: Dec. 18, 2014

(54) CONTEMPORANEOUS TRANSACTION AUTHORIZATION AND TAX DEDUCTIBILITY IDENTIFICATION

(71) Applicant: Bank of America Corporation, Charlotte, NC (US)

(72) Inventors: Glenn M. Grossman, Matthews, NC (US); Kevin Perry, Charlotte, NC (US); Katherine Dintenfass, Charlotte, NC (US); Elizabeth S. Votaw, Potomac, MD (US)

(21) Appl. No.: 13/920,456

(22) Filed: Jun. 18, 2013

(51) Int. Cl. G06Q 40/00; G06Q 20/40

(52) U.S. Cl. CPC G06Q 40/10; G06Q 20/40
USPC 705/31

(57) ABSTRACT

A request to authorize a financial transaction for a customer of a financial institution may be received from a point of sale device. The request may include transaction information indicating a merchant associated with the point of sale device and/or a nature of one or more goods or services associated with the financial transaction. An account of the financial institution associated with the customer of the financial institution may be identified. The financial transaction may be authorized. Contemporaneous to authorizing the financial transaction, a determination may be made that at least a portion of the financial transaction may qualify as a tax deductible expense for the customer of the financial institution. The determination may be based on the transaction information indicating the merchant associated with the point of sale device and/or the nature of one or more goods or services associated with the financial transaction.

### BACKGROUND

Modern tax policy utilizes a system of deductions and credits to incentivize the purchase of certain products and services. Many taxpayers (e.g., those who itemize their deductions) may realize significant tax savings by deducting the maximum level of expenditures permissible under the tax code. Identifying and tracking such expenditures, however, may be a burdensome task. For example, many potentially deductible expenditures (e.g., health care expenses, contributions to charitable organizations, childcare expenses, educational expenses, and the like) may occur sporadically throughout the year and thus may be difficult to track. Accordingly, a need exists for contemporaneous transaction authorization and tax deductibility identification.

### SUMMARY

The following presents a simplified summary in order to provide a basic understanding of some aspects of the disclosure. This summary is not an extensive overview of the disclosure. It is neither intended to identify key or critical elements of the disclosure nor to delineate the scope of the disclosure. The following summary merely presents some concepts of the disclosure in a simplified form as a prelude to the description below.

A request to authorize a financial transaction for a customer of a financial institution may be received from a point of sale device. The request may include transaction information indicating a merchant associated with the point of sale device and/or a nature of one or more goods or services associated with the financial transaction. An account of the financial institution associated with the customer of the financial institution may be identified. The financial transaction for the customer of the financial institution may be authorized. Contemporaneous to authorizing the financial transaction for the customer of the financial institution, a determination may be made that at least a portion of the financial transaction may qualify as a tax deductible expense for the customer of the financial institution. The determination may be based on the transaction information indicating the merchant associated with the point of sale device and/or the nature of one or more goods or services associated with the financial transaction. The at least a portion of the financial transaction that may qualify as a tax deductible expense may be indicated in one or more records of the financial institution that are associated with the customer of the financial institution.

In some embodiments, a notification indicating that the at least a portion of the financial transaction may qualify as a tax deductible expense for the customer of the financial institution may be generated. The notification indicating that the at least a portion of the financial transaction may qualify as a tax deductible expense for the customer of the financial institution may be communicated to a user device associated with the customer of the financial institution. The notification indicating that the at least a portion of the financial transaction may qualify as a tax deductible expense for the customer of the financial institution may be a short message service (SMS) message, a multimedia messaging service (MMS) message, an email, and/or a mobile device application message.

In some embodiments, a confirmation from the user device associated with the customer of the financial institution may be received. The confirmation may indicate that the customer of the financial institution has confirmed that the at least a portion of the financial transaction qualifies as a tax deductible expense for the customer of the financial institution. In some embodiments, the confirmation from the user device associated with the customer of the financial institution may indicate that a first portion of the financial transaction qualifies as a tax deductible expense for the customer of the financial institution and a second portion of the financial transaction does not qualify as a tax deductible expense for the customer of the financial institution. In such embodiments, the fact that the customer of the financial institution has confirmed that the first portion of the financial transaction qualifies as a tax deductible expense for the customer of the financial institution may be indicated in one or more records of the financial institution that are associated with the account of the financial institution associated with the customer of the financial institution.

In some embodiments, the transaction information may indicate a merchant associated with the point of sale device, and determining that the at least a portion of the financial transaction may qualify as a tax deductible expense for the customer of the financial institution may include determining that the merchant is at least one of a charitable organization, a home mortgage payment collector, a childcare provider, a residential relocation or moving provider, an educational institution, or a provider of medical products or services. Additionally or alternatively, the transaction information may indicate a nature of one or more goods or services associated with the financial transaction, and determining that the at least a portion of the financial transaction may qualify as a tax deductible expense for the customer of the financial institution may include determining that the nature of the one or more goods or services associated with the financial transaction comprises at least one of a contribution to a charitable organization, home mortgage interest, a childcare expense, a residential relocation or moving expense, an educational expense, or a medical expense.

In some embodiments, the request to authorize the financial transaction for the customer of the financial institution may comprise a request to authorize a check of the customer of the financial institution. The check may be drawn on the account of the financial institution associated with the customer of the financial institution. The transaction information may indicate a nature of one or more goods or services associated with the financial transaction. The nature of the one or more goods or services associated with the financial transaction may be indicated via a selectable option of the check. When invoked, the selectable option may indicate that the nature of the one or more goods or services associated with the financial transaction qualify as a tax deductible expense for the customer of the financial institution. In such embodiments, determining that the at least a portion of the financial transaction may qualify as a tax deductible expense for the customer of the financial institution may include determining that the selectable option indicating that the nature of the one or more goods or services associated with the financial transaction qualify as a tax deductible expense for the customer of the financial institution has been invoked.

In some embodiments, a tax deductible expenses file may be generated. The tax deductible expenses file may be configured for importation into one or more financial applications. The tax deductible expenses file may include at least one record indicating the at least a portion of the financial transaction that may qualify as a tax deductible expense for the customer of the financial institution. The tax deductible expenses file may be communicated to a user device associated with the customer of the financial institution.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative operating environment for contemporaneous transaction authorization and tax deductibility identification in accordance with one or more example embodiments;

FIGS. 4A, 4B, and 4C depict an illustrative event sequence for contemporaneous transaction authorization and tax deductibility identification in accordance with one or more example embodiments;

FIG. 5 depicts an illustrative confirmation interface for contemporaneous transaction authorization and tax deductibility identification in accordance with one or more example embodiments;

FIG. 6. depicts an illustrative check for contemporaneous transaction authorization and tax deductibility identification in accordance with one or more example embodiments; and

FIG. 7 depicts an illustrative method for contemporaneous transaction authorization and tax deductibility identification in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

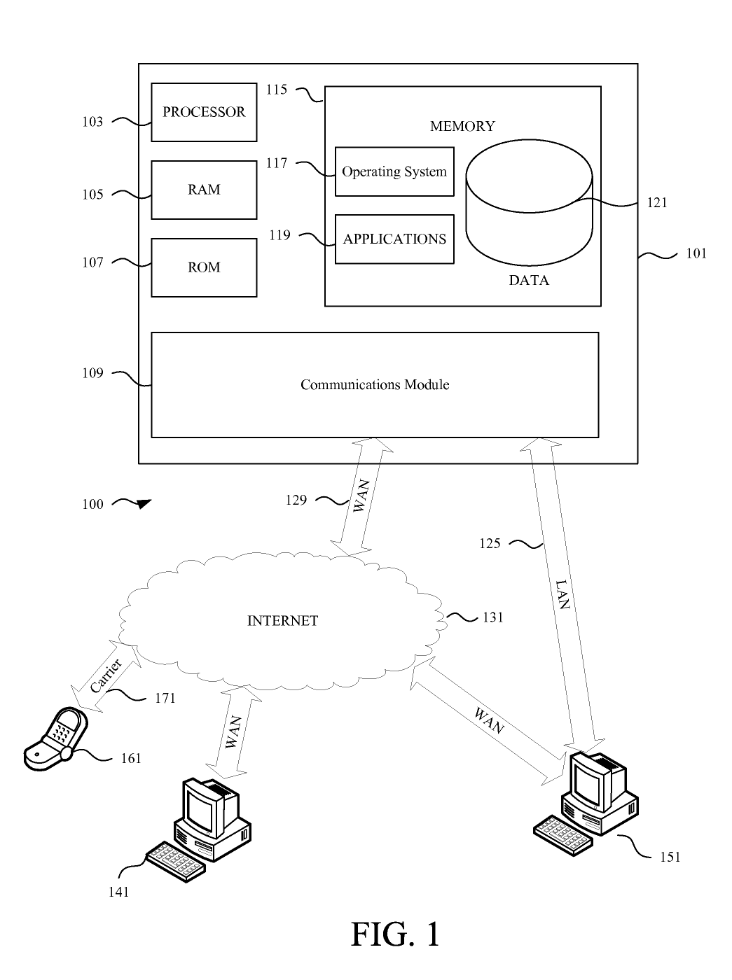

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

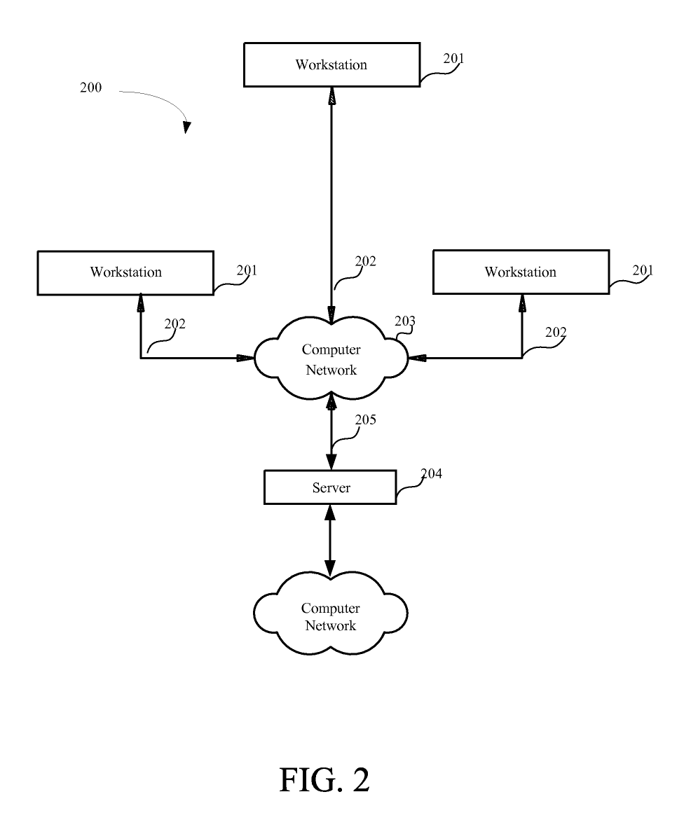

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

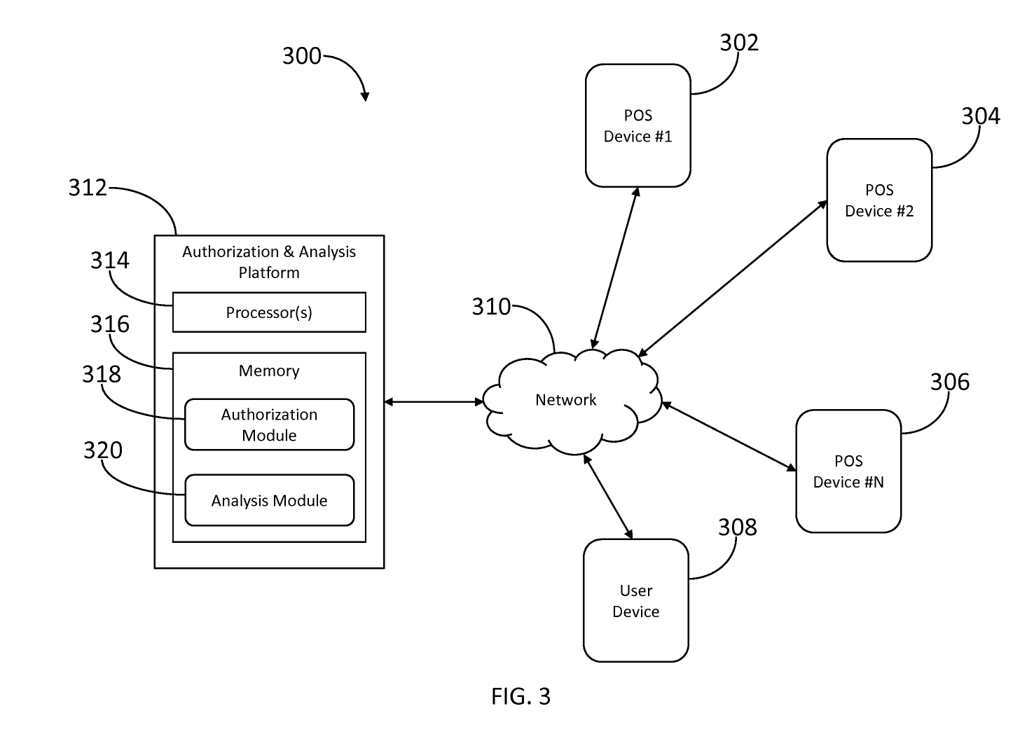

FIG. 3 depicts an illustrative operating environment for contemporaneous transaction authorization and tax deductibility identification in accordance with one or more example embodiments. Referring to FIG. 3, environment 300 may include one or more point of sale (POS) devices. For example, environment 300 may include POS devices 302, 304, and 306. POS devices 302, 304, and/or 306 may be any device or combination of devices configured to accept payment for one or more goods and/or services. For example, POS devices 302, 304, and/or 306 may be a cash register, kiosk, credit/debit card processing terminal, mobile device, smart phone, computing platform, or the like. Environment 300 may also include one or more user devices. For example, environment 300 may include user device 308. User device 308 may be any device associated with a customer of a financial institution that is capable of displaying (or otherwise conveying) one or more messages generated by the financial institution. For example, user device 308 may be a desktop computer, laptop computer, mobile device, smart phone, or the like. Environment 300 may also include network 310. Network 310 may include one or more networks (e.g., LANs, WANs, or the like), and may interconnect one or more of POS devices 302, 304, and/or 306, and/or user device 308.

Environment 300 may further include authorization and analysis platform 312. Authorization and analysis platform 312 may be interconnected with one or more of POS devices 302, 304, and/or 306, and/or user device 308 via network 310. Authorization and analysis platform 312 may include one or more processors and a memory. For example, authorization and analysis platform 312 may include processor(s) 314 and memory 316. Memory 316 may include one or more modules comprising instructions that when executed by processor(s) 314 cause authorization and analysis platform 312 to perform one or more functions described herein. For example, memory 316 may include authorization module 318 and analysis module 320.

As will be described in greater detail below, authorization and analysis platform 312 may receive a request to authorize a financial transaction for a customer of a financial institution from a point of sale device (e.g., from POS device 302, 304, or 306). The request may include transaction information indicating a merchant associated with the point of sale device (e.g., a merchant associated with POS device 302, 304, or 306) and/or a nature of one or more goods or services associated with the financial transaction (e.g., one or more goods or services the customer of the financial institution is seeking to purchase from the merchant associated with POS device 302, 304, or 306). Authorization and analysis platform 312 may identify an account of the financial institution that is associated with the customer of the financial institution. Authorization and analysis platform 312 may authorize the financial transaction for the customer of the financial institution (e.g., based on information associated with the identified account of the financial institution that is associated with the customer of the financial institution).

Contemporaneous to authorizing the financial transaction for the customer of the financial institution, authorization and analysis platform 312 may determine, based on the transaction information (e.g., the merchant associated with POS device 302, 304, or 306, and/or the one or more goods or services the customer of the financial institution is seeking to purchase from the merchant associated with POS device 302, 304, or 306) that at least a portion of the financial transaction may qualify as a tax deductible expense for the customer of the financial institution. Responsive to determining that the at least a portion of the financial transaction may qualify as a tax deductible expense for the customer of the financial institution, authorization and analysis platform 312 may indicate that the at least a portion of the financial transaction may qualify as a tax deductible expense for the customer of the financial institution in one or more records of the financial institution associated with the account of the financial institution that is associated with the customer of the financial institution.

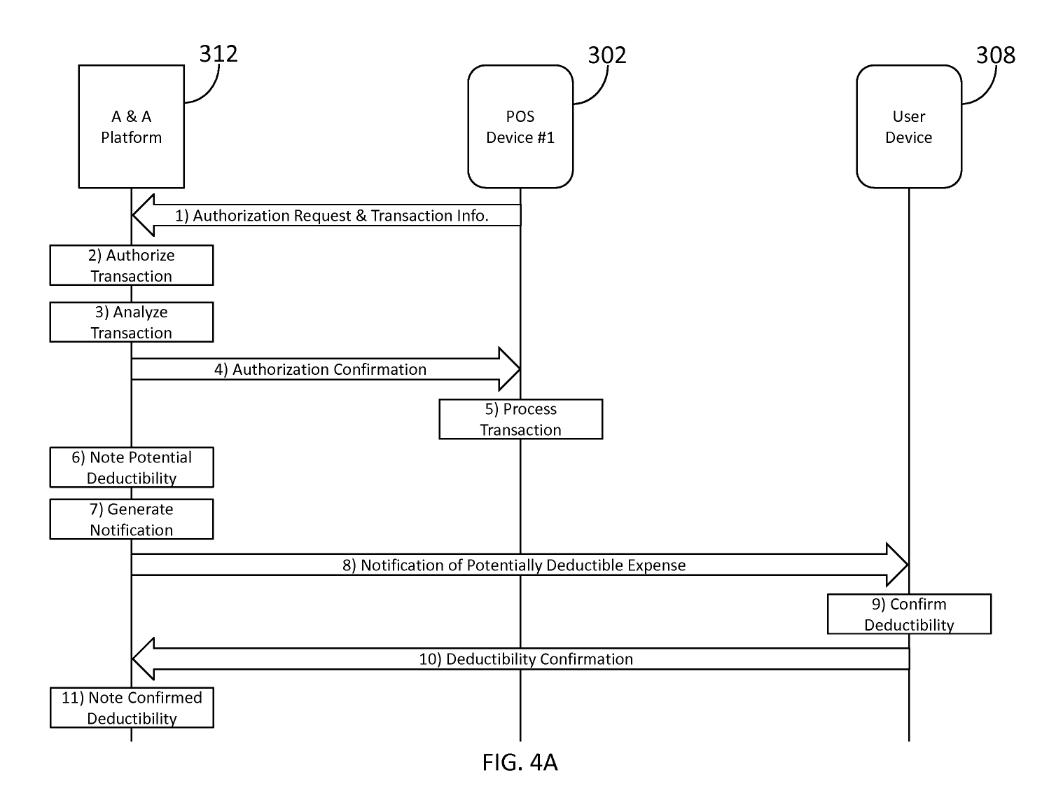

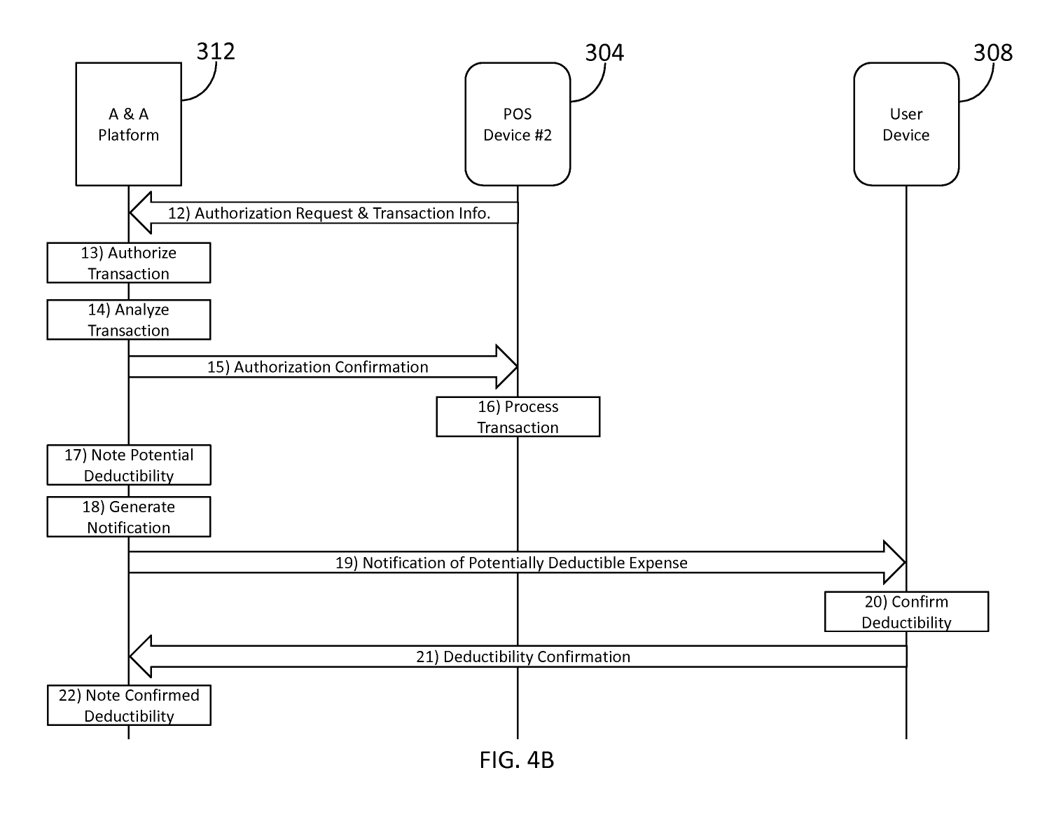

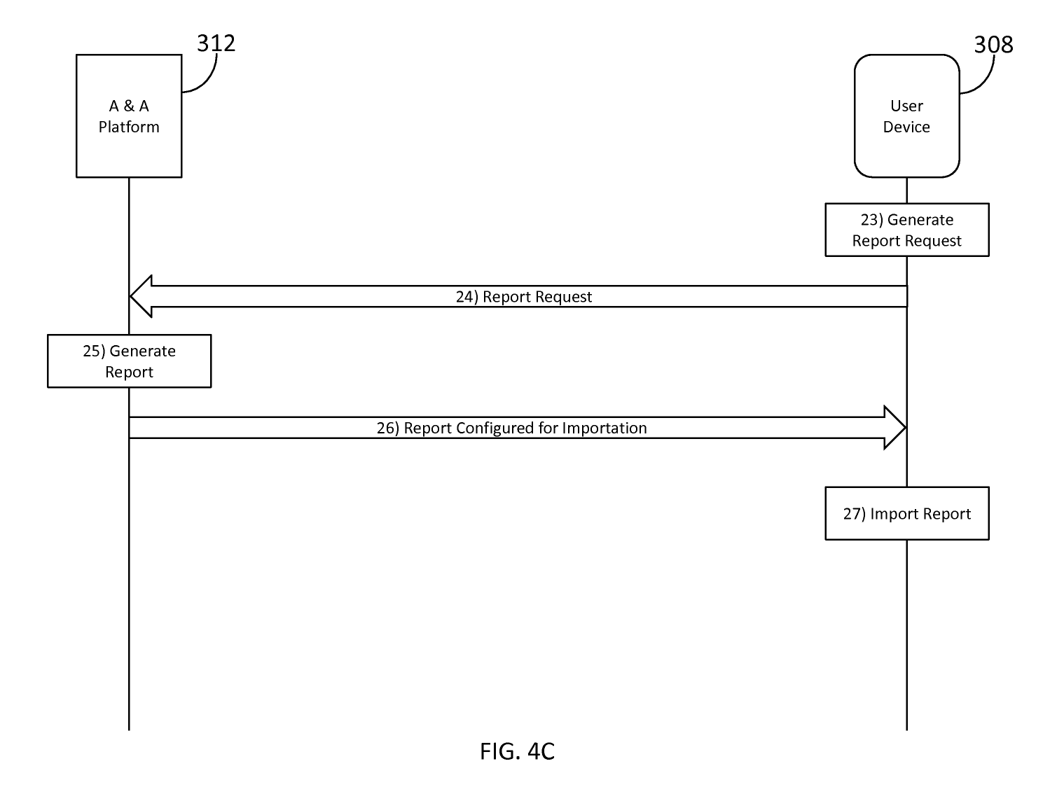

FIGS. 4A, 4B, and 4C depict an illustrative event sequence for contemporaneous transaction authorization and tax deductibility identification in accordance with one or more example embodiments. Referring to FIG. 4A, at step 1, authorization and analysis platform 312 may receive a request to authorize a financial transaction for a customer of a financial institution from POS device 302. The request may include transaction information indicating a merchant associated with the point of sale device (e.g., a merchant associated with POS device 302) and/or a nature of one or more goods or services associated with the financial transaction (e.g., one or more goods or services the customer of the financial institution is seeking to purchase from the merchant associated with POS device 302). At step 2, authorization and analysis platform 312 may authorize the financial transaction. For example, the request to authorize the financial transaction may include an amount associated with the financial transaction, and authorization and analysis platform 312 may identify an account (e.g., a deposit account, credit line, or the like) of the financial institution associated with the customer of the financial institution and may verify that the identified account is in a condition that warrants authorization of the financial transaction (e.g., sufficient funds are available, sufficient credit is available, or the like).

At step 3, contemporaneous to authorizing the financial transaction, authorization and analysis platform 312 may analyze the financial transaction. For example, authorization and analysis platform 312 may examine the transaction information indicating the merchant associated with the point of sale device (e.g., a merchant associated with POS device 302) and/or the nature of the one or more goods or services associated with the financial transaction (e.g., one or more goods or services the customer of the financial institution is seeking to purchase from the merchant associated with POS device 302), and may determine that at least a portion of the financial transaction may qualify as a tax deductible expense for the customer of the financial institution. In some embodiments, authorization and analysis platform 312 may analyze the financial transaction (e.g., may determine that the at least a portion of the financial transaction may qualify as a tax deductible expense for the customer of the financial institution) in response to authorizing the financial transaction. In some embodiments, the financial transaction may be analyzed simultaneous to authorizing the financial transaction (e.g., real time). Additionally or alternatively, the financial transaction may be analyzed within a few minutes of authorizing the financial transaction (e.g., near real time). In some embodiments, the financial transaction may be analyzed by one or more computers utilized to authorize the financial transaction. Alternatively, the financial transaction may be analyzed by one or more computers distinct from one or more computers utilized to authorize the financial transaction.

In some embodiments, the transaction information may indicate a merchant associated with the point of sale device (e.g., a merchant associated with POS device 302), and determining that the at least a portion of the financial transaction may qualify as a tax deductible expense for the customer of the financial institution may include determining that the merchant (e.g., the merchant associated with POS device 302) is at least one of a charitable organization, a home mortgage payment collector, a childcare provider, a residential relocation or moving provider, an educational institution, or a provider of medical products or services. Additionally or alternatively, the transaction information may indicate a nature of one or more goods or services associated with the financial transaction (e.g., one or more goods or services the customer of the financial institution is seeking to purchase from the merchant associated with POS device 302), and determining that the at least a portion of the financial transaction may qualify as a tax deductible expense for the customer of the financial institution may include determining that the nature of the one or more goods or services associated with the financial transaction (e.g., one or more goods or services the customer of the financial institution is seeking to purchase from the merchant associated with POS device 302) comprises at least one of a contribution to a charitable organization, home mortgage interest, a childcare expense, a residential relocation or moving expense, an educational expense, or a medical expense.

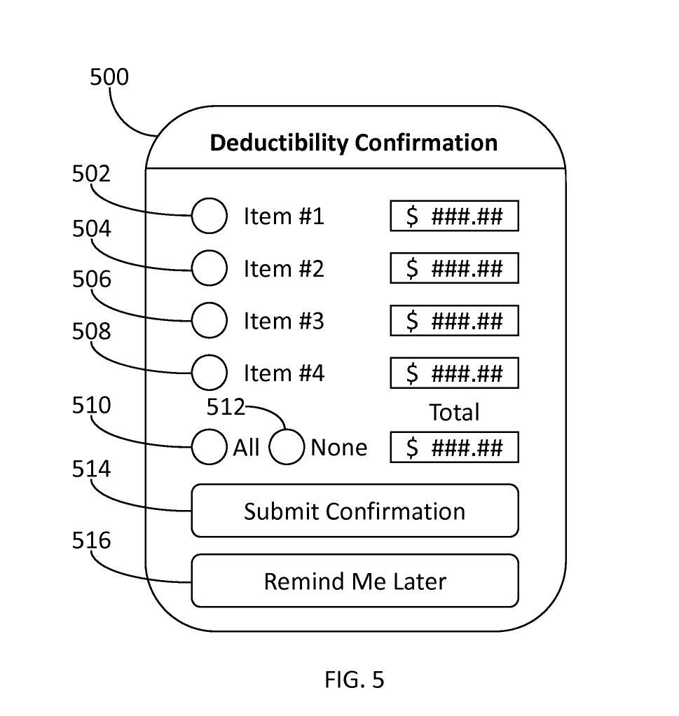

At step 4, authorization and analysis platform 312 may communicate an authorization confirmation to POS device 302, and, at step 5, responsive to receiving the authorization confirmation, POS device 302 may process the financial transaction. At step 6, authorization and analysis platform 312 may indicate that the at least a portion of the financial transaction may qualify as a tax deductible expense for the customer of the financial institution in one or more records of the financial institution associated with the account of the financial institution that is associated with the customer of the financial institution. At step 7, authorization and analysis platform 312 may generate a notification indicating that the at least a portion of the financial transaction may qualify as a tax deductible expense for the customer of the financial institution. In some embodiments, the notification indicating that the at least a portion of the financial transaction may qualify as a tax deductible expense for the customer of the financial institution may be a short message service (SMS) message, a multimedia messaging service (MMS) message, an email, and/or a mobile device application message. For example, the notification indicating that the at least a portion of the financial transaction may qualify as a tax deductible expense for the customer of the financial institution may be a mobile device application confirmation interface similar to that depicted in FIG. 5.

Referring to FIG. 5, interface 500 may include a synopsis of the recent financial transaction (e.g., the financial transaction associated with POS device 302). The synopsis may include a description of the merchant associated with the financial transaction (e.g., a merchant associated with POS device 302) and/or a list of one or more items (e.g., products, services, or the like) purchased as part of the financial transaction. The interface may provide one or more selectable options associated with the financial transaction and/or the one or more items purchased as part of the financial transaction. These selectable option(s) may be utilized by the user to confirm that at least a portion of the one or more items purchased as part of the financial transaction are tax deductible for the customer of the financial institution. For example, interface 500 may include selectable options 502, 504, 506, 508, 510, and 512. Selectable options 502, 504, 506, and 508 may each be associated with individual items (or categories of items) purchased as part of the financial transaction (e.g., “Item #1,” “Item #2,” “Item #3,” and “Item #4,” respectively), and may, when invoked by the customer of the financial institution, be used to confirm that the corresponding item (or category) is a tax deductible expense for the customer of the financial institution.

Selectable option 510 may be associated with a total amount of funds associated with the financial transaction (e.g., the total amount of “Item #1,” “Item #2,” “Item #3,” and “Item #4”), and may, when invoked by the customer of the financial institution, be used to confirm that the total amount of funds associated with the financial transaction is a tax deductible expense for the customer of the financial institution. Selectable option 512 may be associated with a “none” option, and may, when invoked by the customer of the financial institution, be used to confirm that none of the items purchased as part of the financial transaction are tax deductible expenses for the customer of the financial institution. Interface 500 may also include selectable options 514 and 516. Selectable option 514 may, when invoked by the customer of the financial institution, confirm that at least a portion of the financial transaction (e.g., an amount associated with one or more of “Item #1,” “Item #2,” “Item #3,” and “Item #4”) is a tax deductible expense for the customer of the financial institution. Selectable option 516 may, when invoked by the customer of the financial institution, indicate that the customer of the financial institution wishes to address the tax deductibility of the financial transaction (or a portion thereof) at a later time.

Returning to FIG. 4A, at step 8, authorization and analysis platform 312, may communicate the notification indicating that the at least a portion of the financial transaction may qualify as a tax deductible expense for the customer of the financial institution to user device 308. For example, authorization and analysis platform 312 may identify user device 308 as being associated with the customer of the financial institution and may communicate interface 500 to user device 308. At step 9, the customer of the financial institution may confirm the tax deductibility of at least a portion of the financial transaction (e.g., by invoking one or more of selectable options 502, 504, 506, 508, 510, 512, and 514). At step 10, user device 308 may communicate the confirmation of the tax deductibility of the at least a portion of the financial transaction to authorization and analysis platform 312 (e.g., “Item #1,” “Item #2,” “Item #3,” and “Item #4” (and/or amounts associated therewith)), and, at step 11, authorization and analysis platform 312 may indicate the confirmed deductibility in one or more records of the financial institution that are associated with the account of the financial institution that is associated with the customer of the financial institution.

In some embodiments, the confirmation of the tax deductibility of the at least a portion of the financial transaction may indicate that a first portion of the financial transaction is tax deductible for the customer of the financial institution and that a second portion of the financial transaction is not tax deductible for the customer of the financial institution. For example, the customer of the financial institution may have indicated that “Item #1” and “Item #2” of the financial transaction are tax deductible for the customer of the financial institution (e.g., by invoking selectable options 502 and 504), and may further indicate that “Item #3” and “Item #4” of the financial transaction are not tax deductible for the customer of the financial institution (e.g., by failing to invoke selectable options 506 and 508). In such embodiments, authorization and analysis platform 312 may indicate that the first portion of the financial transaction (e.g., “Item #1” and “Item #2” (and/or amounts associated therewith)) is tax deductible for the customer of the financial institution in one or more records of the financial institution associated with the account of the financial institution that is associated with the customer of the financial institution and may fail to indicate that the second portion of the financial transaction (e.g., “Item #3” and “Item #4” (and/or amounts associated therewith)) is tax deductible for the customer of the financial institution in the one or more records of the financial institution associated with the account of the financial institution that is associated with the customer of the financial institution.

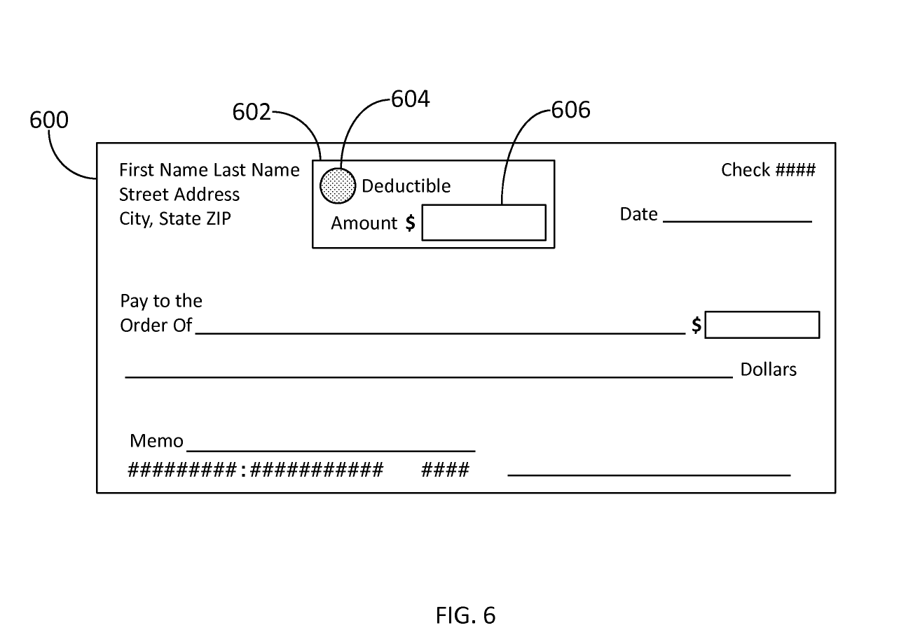

Referring to FIG. 4B, at step 12, authorization and analysis platform 312 may receive a request to authorize a financial transaction for a customer of a financial institution from POS device 304. In some embodiments, the request to authorize the financial transaction for the customer of the financial institution may comprise a request to authorize a check of the customer of the financial institution. The request may include transaction information indicating a merchant associated with the point of sale device (e.g., a merchant associated with POS device 304) and/or a nature of one or more goods or services associated with the financial transaction (e.g., one or more goods or services the customer of the financial institution is seeking to purchase from the merchant associated with POS device 304). The nature of the one or more goods or services associated with the financial transaction may be indicated via a selectable option of the check. For example, the request may be to authorize a check similar to the check depicted in FIG. 6. Referring to FIG. 6, check 600 may include tax deductibility region 602. Tax deductibility region 602 may include selectable option 604. Selectable option 604, when invoked (e.g., by shading, marking, or the like), may indicate that the nature of the one or more goods or services associated with the financial transaction qualify as a tax deductible expense for the customer of the financial institution.

Returning to FIG. 4B, at step 13, authorization and analysis platform 312 may authorize the financial transaction. For example, the check may be drawn on an account of the financial institution associated with the customer of the financial institution, the request to authorize the financial transaction may include an amount associated with the financial transaction, and authorization and analysis platform 312 may identify the account (e.g., a deposit account, credit line, or the like) of the financial institution associated with the customer of the financial institution (e.g., the account the check is drawn on) and may verify that the identified account is in a condition that warrants authorization of the financial transaction (e.g., sufficient funds are available, sufficient credit is available, or the like). At step 14, contemporaneous to authorizing the financial transaction, authorization and analysis platform 312 may analyze the financial transaction. For example, authorization and analysis platform 312 may examine the transaction information indicating the merchant associated with the point of sale device (e.g., a merchant associated with POS device 304) and/or the nature of the one or more goods or services associated with the financial transaction (e.g., one or more goods or services the customer of the financial institution is seeking to purchase from the merchant associated with POS device 304), and may determine that at least a portion of the financial transaction may qualify as a tax deductible expense for the customer of the financial institution. In some embodiments, authorization and analysis platform 312 may determine that the at least a portion of the financial transaction may qualify as a tax deductible expense for the customer of the financial institution by determining (e.g., via an image analysis of the check) that selectable option 604 indicating that the nature of the one or more goods or services associated with the financial transaction qualify as a tax deductible expense for the customer of the financial institution has been invoked.

At step 15, authorization and analysis platform 312 may communicate an authorization confirmation to POS device 304, and, at step 16, responsive to receiving the authorization confirmation, POS device 304 may process the financial transaction. At step 17, authorization and analysis platform 312 may indicate that the at least a portion of the financial transaction may qualify as a tax deductible expense for the customer of the financial institution in one or more records of the financial institution associated with the account of the financial institution that is associated with the customer of the financial institution. At step 18, authorization and analysis platform 312 may generate a notification indicating that the at least a portion of the financial transaction may qualify as a tax deductible expense for the customer of the financial institution (e.g., a mobile device application confirmation interface similar to that depicted in FIG. 5). At step 19, authorization and analysis platform 312, may communicate the notification indicating that the at least a portion of the financial transaction may qualify as a tax deductible expense for the customer of the financial institution to user device 308. For example, authorization and analysis platform 312 may identify user device 308 as being associated with the customer of the financial institution and may communicate interface 500 to user device 308. At step 20, the customer of the financial institution may confirm the tax deductibility of at least a portion of the financial transaction (e.g., by invoking one or more selectable options of a mobile device application confirmation interface similar to that depicted in FIG. 5). At step 21, user device 308 may communicate the confirmation of the tax deductibility of the at least a portion of the financial transaction to authorization and analysis platform 312, and, at step 22, authorization and analysis platform 312 may indicate the confirmed deductibility in one or more records of the financial institution that are associated with the account of the financial institution that is associated with the customer of the financial institution.

In some embodiments, the confirmation of the tax deductibility of the at least a portion of the financial transaction may indicate that a first portion of the financial transaction is tax deductible for the customer of the financial institution and that a second portion of the financial transaction is not tax deductible for the customer of the financial institution. For example, referring to FIG. 6, the customer of the financial institution may have indicated that only a portion of the financial transaction is tax deductible for the customer of the financial institution by writing an amount less than the total amount associated with the financial transaction (e.g., the amount on which the authorization was based) in region 606. In such embodiments, authorization and analysis platform 312 may indicate that the first portion of the financial transaction (e.g., the amount indicated by the customer in region 606) is tax deductible for the customer of the financial institution in one or more records of the financial institution associated with the account of the financial institution that is associated with the customer of the financial institution and may fail to indicate that the second portion of the financial transaction (e.g., the difference between the total amount associated with the financial transaction and the amount indicated by the customer in region 606) is tax deductible for the customer of the financial institution in the one or more records of the financial institution associated with the account of the financial institution that is associated with the customer of the financial institution.

Referring to FIG. 4C, at step 23, user device 308 may generate a request for a tax deductible expenses file. In some embodiments, the request may specify one or more formats for the tax deductible expenses file (e.g., one or more formats suitable for importation into one or more financial applications). At step 24, user device 308 may communicate the request for the tax deductible expenses file to authorization and analysis platform 312. At step 25, authorization and analysis platform 312 may generate the tax deductible expenses file. In some embodiments, authorization and analysis platform 312 may configure and/or format the tax deductible expenses file for importation into one or more financial applications (e.g., one or more financial applications specified in the request for the tax deductible expenses file). The generated tax deductible expenses file may include one or more records comprising portions of financial transactions determined and/or confirmed to be deductible for the customer of the financial institution (e.g., one or more portions of financial transactions confirmed by the customer of the financial institution to be tax deductible for the customer of the financial institution in steps 9 and 20). At step 26, authorization and analysis platform 312 may communicate the generated tax deductible expenses file to user device 308, which may, at step 27, import the tax deductible expenses file into one or more financial applications (e.g., one or more financial applications for generating a tax return).

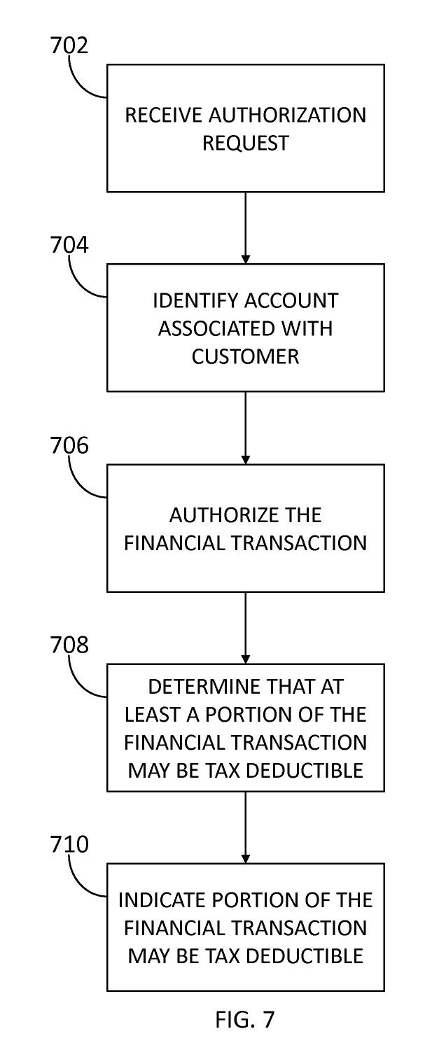

FIG. 7 depicts an illustrative method for contemporaneous transaction authorization and tax deductibility identification in accordance with one or more example embodiments. Referring to FIG. 7, at step 702, a request to authorize a financial transaction for a customer of a financial institution may be received from a point of sale device. For example, authorization and analysis platform 312 may receive a request to authorize a financial transaction for a customer of a financial institution associated with authorization and analysis platform 312 from POS device 302. The request may include transaction information indicating a merchant associated with the point of sale device and/or a nature of one or more goods or services associated with the financial transaction. For example, the request may include transaction information indicating a merchant associated with POS device 302 and/or a nature of one or more goods or services that the customer of the financial institution is seeking to purchase from the merchant associated with POS device 302. At step 704, an account of the financial institution associated with the customer of the financial institution may be identified. For example, authorization and analysis platform 312 may identify an account of the financial institution associated with authorization and analysis platform 312 that is associated with the customer of the financial institution. At step 706, the financial transaction for the customer of the financial institution may be authorized. For example, authorization and analysis platform 312 may authorize the financial transaction for the customer of the financial institution associated with authorization and analysis platform 312.

At step 708, contemporaneous to authorizing the financial transaction for the customer of the financial institution, a determination may be made that at least a portion of the financial transaction may qualify as a tax deductible expense for the customer of the financial institution. For example, authorization and analysis platform 312 may determine that at least a portion of the financial transaction may qualify as a tax deductible expense for the customer of the financial institution associated with authorization and analysis platform 312. The determination may be based on the transaction information indicating the merchant associated with the point of sale device and/or the nature of one or more goods or services associated with the financial transaction. For example, the determination that the at least a portion of the financial transaction may qualify as a tax deductible expense for the customer of the financial institution associated with authorization and analysis platform 312 may be based on the transaction information received from POS device 302. At step 710, the at least a portion of the financial transaction that may qualify as a tax deductible expense may be indicated in one or more records of the financial institution that are associated with the customer of the financial institution. For example, the at least a portion of the financial transaction that may qualify as a tax deductible expense for the customer of the financial institution associated with authorization and analysis platform 312 may be indicated in one or more records of the financial institution associated with authorization and analysis platform 312 that are associated with the account of the customer of financial institution associated with authorization and analysis platform 312.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method performed at least in part by a computing platform associated with a financial institution, said computing platform comprising at least one processor, a memory, and a communication interface, the method comprising:
receiving, via the communication interface and from a point of sale device, a request to authorize a financial transaction for a customer of the financial institution, wherein said request comprises transaction information indicating at least one of a merchant associated with the point of sale device or a nature of one or more goods or services associated with the financial transaction;
identifying, by the at least one processor, an account of the financial institution associated with the customer of the financial institution;
authorizing, by the at least one processor, the financial transaction for the customer of the financial institution;
contemporaneous to authorizing the financial transaction for the customer of the financial institution, determining, by the at least one processor and based on the transaction information indicating the at least one of the merchant associated with the point of sale device or the nature of the one or more goods or services associated with the financial transaction, that at least a portion of the financial transaction may qualify as a tax deductible expense for the customer of the financial institution; and
indicating, by the at least one processor and in one or more records of the financial institution that are associated with the account of the financial institution associated with the customer of the financial institution, that the at least a portion of the financial transaction may qualify as a tax deductible expense for the customer of the financial institution.

2. The method of claim 1, comprising:
generating a notification indicating that the at least a portion of the financial transaction may qualify as a tax deductible expense for the customer of the financial institution; and
communicating the notification indicating that the at least a portion of the financial transaction may qualify as a tax deductible expense for the customer of the financial institution to a user device associated with the customer of the financial institution.

3. The method of claim 2, comprising receiving a confirmation from the user device associated with the customer of the financial institution, the confirmation indicating that the customer of the financial institution has confirmed that the at least a portion of the financial transaction qualifies as a tax deductible expense for the customer of the financial institution.

4. The method of claim 3, wherein the confirmation from the user device associated with the customer of the financial institution indicates that a first portion of the financial transaction qualifies as a tax deductible expense for the customer of the financial institution and a second portion of the financial transaction does not qualify as a tax deductible expense for the customer of the financial institution.

5. The method of claim 4, comprising indicating in one or more records of the financial institution that are associated with the account of the financial institution associated with the customer of the financial institution, that the customer of the financial institution has confirmed that the first portion of the financial transaction qualifies as a tax deductible expense for the customer of the financial institution.

6. The method of claim 2, wherein the notification indicating that the at least a portion of the financial transaction may qualify as a tax deductible expense for the customer of the financial institution comprises at least one of a short message service (SMS) message, a multimedia messaging service (MMS) message, an email, or a mobile device application message.

7. The method of claim 1, wherein the transaction information indicates a merchant associated with the point of sale device, and wherein determining that the at least a portion of the financial transaction may qualify as a tax deductible expense for the customer of the financial institution comprises determining that the merchant is at least one of a charitable organization, a home mortgage payment collector, a childcare provider, a residential relocation or moving provider, an educational institution, or a provider of medical products or services.

8. The method of claim 1, wherein the transaction information indicates a nature of one or more goods or services associated with the financial transaction, and wherein determining that the at least a portion of the financial transaction may qualify as a tax deductible expense for the customer of the financial institution comprises determining that the nature of the one or more goods or services associated with the financial transaction comprises at least one of a contribution to a charitable organization, home mortgage interest, a childcare expense, a residential relocation or moving expense, an educational expense, or a medical expense.

9. The method of claim 1, wherein:
the request to authorize the financial transaction for the customer of the financial institution comprises a request to authorize a check of the customer of the financial institution, the check being drawn on the account of the financial institution associated with the customer of the financial institution;
the transaction information indicates a nature of one or more goods or services associated with the financial transaction;
the nature of the one or more goods or services associated with the financial transaction is indicated via a selectable option of the check, said selectable option, when invoked, indicating that the nature of the one or more goods or services associated with the financial transaction qualify as a tax deductible expense for the customer of the financial institution; and
determining that the at least a portion of the financial transaction may qualify as a tax deductible expense for the customer of the financial institution comprises determining that the selectable option indicating that the nature of the one or more goods or services associated with the financial transaction qualify as a tax deductible expense for the customer of the financial institution has been invoked.

10. The method of claim 1, comprising:
generating a tax deductible expenses file, the tax deductible expenses file being configured for importation into one or more financial applications, and the tax deductible expenses file comprising at least one record indicating the at least a portion of the financial transaction that may qualify as a tax deductible expense for the customer of the financial institution; and
communicating the tax deductible expenses file to a user device associated with the customer of the financial institution.

11. An apparatus, comprising:
at least one processor; and
a memory storing instructions that when executed by the at least one processor cause the apparatus to:
receive, from a point of sale device, a request to authorize a financial transaction for a customer of a financial institution, wherein said request comprises transaction information indicating at least one of a merchant associated with the point of sale device or a nature of one or more goods or services associated with the financial transaction;
identify an account of the financial institution associated with the customer of the financial institution;
contemporaneously authorize the financial transaction for the customer of the financial institution and determine, based on the transaction information indicating the at least one of the merchant associated with the point of sale device or the nature of the one or more goods or services associated with the financial transaction, that at least a portion of the financial transaction may qualify as a tax deductible expense for the customer of the financial institution;
generate a notification indicating that the at least a portion of the financial transaction may qualify as a tax deductible expense for the customer of the financial institution; and
communicate the notification indicating that the at least a portion of the financial transaction may qualify as a tax deductible expense for the customer of the financial institution to a user device associated with the customer of the financial institution.

12. The apparatus of claim 11, wherein the instructions when executed by the at least one processor cause the apparatus to receive a confirmation from the user device associated with the customer of the financial institution, the confirmation indicating that the customer of the financial institution has confirmed that the at least a portion of the financial transaction qualifies as a tax deductible expense for the customer of the financial institution.

13. The apparatus of claim 12, wherein the confirmation from the user device associated with the customer of the financial institution indicates that a first portion of the financial transaction qualifies as a tax deductible expense for the customer of the financial institution and a second portion of the financial transaction does not qualify as a tax deductible expense for the customer of the financial institution.

14. The apparatus of claim 13, wherein the instructions when executed by the at least one processor cause the apparatus to indicate in one or more records of the financial institution that are associated with the account of the financial institution associated with the customer of the financial institution, that the customer of the financial institution has confirmed that the first portion of the financial transaction qualifies as a tax deductible expense for the customer of the financial institution.

15. The apparatus of claim 11, wherein the notification indicating that the at least a portion of the financial transaction may qualify as a tax deductible expense for the customer of the financial institution comprises at least one of a short message service (SMS) message, a multimedia messaging service (MMS) message, an email, or a mobile device application message.

16. The apparatus of claim 11, wherein the transaction information indicates a merchant associated with the point of sale device, and wherein the instructions when executed by the at least one processor cause the apparatus to determine that the at least a portion of the financial transaction may qualify as a tax deductible expense for the customer of the financial institution by determining that the merchant is at least one of a charitable organization, a home mortgage payment collector, a childcare provider, a residential relocation or moving provider, an educational institution, or a provider of medical products or services.

17. The apparatus of claim 11, wherein the transaction information indicates a nature of one or more goods or services associated with the financial transaction, and wherein the instructions when executed by the at least one processor cause the apparatus to determine that the at least a portion of the financial transaction may qualify as a tax deductible expense for the customer of the financial institution by determining that the nature of the one or more goods or services associated with the financial transaction comprises at least one of a contribution to a charitable organization, home mortgage interest, a childcare expense, a residential relocation or moving expense, an educational expense, or a medical expense.

18. The apparatus of claim 11, wherein:
the request to authorize the financial transaction for the customer of the financial institution comprises a request to authorize a check of the customer of the financial institution, the check being drawn on the account of the financial institution associated with the customer of the financial institution;
the transaction information indicates a nature of one or more goods or services associated with the financial transaction;
the nature of the one or more goods or services associated with the financial transaction is indicated via a selectable option of the check, said selectable option, when invoked, indicating that the nature of the one or more goods or services associated with the financial transaction qualify as a tax deductible expense for the customer of the financial institution; and
the instructions when executed by the at least one processor cause the apparatus to determine that the at least a portion of the financial transaction may qualify as a tax deductible expense for the customer of the financial institution by determining that the selectable option indicating that the nature of the one or more goods or services associated with the financial transaction qualify as a tax deductible expense for the customer of the financial institution has been invoked.

19. The apparatus of claim 11, wherein the instructions when executed by the at least one processor cause the apparatus to:
generate a tax deductible expenses file, the tax deductible expenses file being configured for importation into one or more financial applications, and the tax deductible expenses file comprising at least one record indicating the at least a portion of the financial transaction that may qualify as a tax deductible expense for the customer of the financial institution; and
communicate the tax deductible expenses file to a user device associated with the customer of the financial institution.

20. One or more non-transitory computer-readable media having instructions stored thereon, that when executed by one or more computers, cause the one or more computers to:
receive, from a point of sale device, a request to authorize a financial transaction for a customer of a financial institution, wherein said request comprises transaction information indicating at least one of a merchant associated with the point of sale device or a nature of one or more goods or services associated with the financial transaction;
identify an account of the financial institution associated with the customer of the financial institution;
contemporaneously authorize the financial transaction for the customer of the financial institution and determine, based on the transaction information indicating the at least one of the merchant associated with the point of sale device or the nature of the one or more goods or services associated with the financial transaction, that at least a portion of the financial transaction may qualify as a tax deductible expense for the customer of the financial institution; and
indicate in one or more records of the financial institution that are associated with the account of the financial institution associated with the customer of the financial institution, that the at least a portion of the financial transaction may qualify as a tax deductible expense for the customer of the financial institution.
